(19) United States
(12) Patent Application Publication
(10) Pub. No.: US 2005/0274565 A1
(43) Pub. Date: Dec. 15, 2005

(54) Steer by wire motor control algorithm

(76) Inventors: Randall G. Greenwell, Troy, MI (US); David S. Cameron, Grosse Pointe Woods, MI (US); Sanjeev M. Naik, Troy, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 10/864,671

(22) Filed: Jun. 9, 2004

(51) Int. Cl. B62D 5/00

(52) U.S. Cl. 180/402

(57) ABSTRACT

A steer by wire system for a vehicle that employs a steering torque assist to allow the vehicle operator to more easily steer the vehicle in the event of a steer by wire system fault. The steer by wire system includes a sensor that generates a signal indicative of the position of and torque applied to the steering wheel that is received by a controller. From the position signal, the controller controls the steering of the vehicle by a steering motor. A feedback motor provides counter-torque to the rotation of the steering wheel to simulate the turning of the vehicle wheels. If the steer by wire system fails, a clutch engages a mechanical linkage to allow the vehicle operator to control the vehicle steering by the steering wheel. The controller provides a motor drive signal to the feedback motor to provide the torque assist when the mechanical linkage is engaged.

### BACKGROUND OF THE INVENTION

1. Field of the Invention

This invention relates generally to a steer by wire control system for a vehicle and, more particularly, to a steer by wire control system for a vehicle, where the control system uses a driver feedback motor to provide a steering torque assist for a mechanical steering linkage in the event of a steer by wire system fault.

2. Discussion of the Related Art

Experimental vehicles employing steer by wire systems are known in the art. A steer by wire system allows the vehicle to be steered electronically, i.e., without a direct mechanical link between the steering wheel and the vehicle wheels. Steer by wire systems allow vehicle interior design freedoms that might otherwise not be possible with a conventional steering system having a mechanical linkage. Further, steer by wire systems typically have fewer parts and reduced complexity than the conventional steering systems.

One known steer by wire system employs a position and torque sensor that senses the rotation of the vehicle steering wheel and generates a position signal that is received by a controller. From the position of the steering wheel, the controller generates a drive signal that controls a steering motor for steering the vehicle's wheels. A driver feedback motor coupled to the steering wheel simulates a mechanical linkage between the steering wheel and the vehicle wheels to provide stability and feel to the steering wheel. In other words, the feedback motor provides a counter-torque to the direction that the steering wheel is turned to give the vehicle operator the sensation of resistance caused by the turning of the vehicle.

It is still desirable in steer by wire vehicles to employ some type of mechanical steering linkage between the vehicle wheels and the steering wheel that allows the vehicle operator to steer the vehicle if the steer by wire system fails. One known design employs a clutch that disengages the mechanical linkage when the steer by wire system is operating properly. A clutch control signal from the controller engages the clutch, and thus the mechanical linkage, if the controller determines the steer by wire system is not operating properly, so that the vehicle operator is still able to steer the vehicle. However, this system does not employ a steering assist to help the operator steer the vehicle by the mechanical linkage. Therefore, the vehicle must be steered by an “armstrong” or brute force technique if the steer by wire system fails that may be beyond the vehicle operator's capabilities.

### SUMMARY OF THE INVENTION

In accordance with the teachings of the present invention, a steer by wire system for a vehicle is disclosed that employs a steering torque assist to allow the vehicle operator to more easily steer the vehicle in the event that the steer by wire system fails. The steer by wire system includes a steering wheel position and torque sensor that generates a signal indicative of the position of and torque applied to the steering wheel that is received by a controller. From the position signal, the controller controls the steering of the vehicle by a steering motor. A feedback torque motor provides counter-torque to the rotation of the steering wheel to simulate the turning of the vehicle wheels. If the steer by wire system fails, a clutch engages a mechanical linkage to allow the vehicle operator to control the vehicle steering by the steering wheel. The controller then provides a motor drive signal to the feedback torque motor to provide the torque assist when the mechanical linkage is engaged.

Additional advantages and features of the present invention will become apparent from the following description and appended claims, taken in conjunction with the accompanying drawings.

### BRIEF DESCRIPTION OF THE DRAWING

FIG. 1 is a plan view of a steer by wire system employing a torque assist motor for providing steering assist during a failure condition, according to an embodiment of the present invention.

### DETAILED DISCUSSION OF THE EMBODIMENTS

The following discussion of the embodiments of the invention directed to a steer by wire control system employing a steering torque assist is merely exemplary in nature and is in no way intended to limit the invention or its applications or uses.

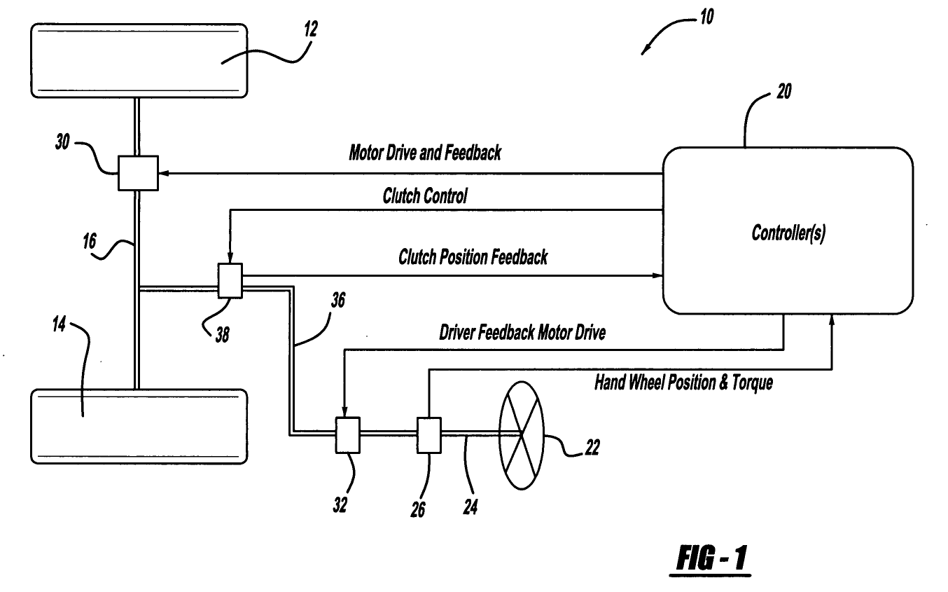

FIG. 1 is a plan view of a steer by wire control system 10, according to an embodiment of the present invention. The system 10 includes vehicle wheels 12 and 14 connected together by an axle 16. The vehicle wheels 12 and 14 are intended to represent vehicle front wheels in this embodiment, however, the steer by wire control system can be used for vehicles that have rear wheel steering. The steer by wire control system 10 is controlled by a controller 20. The controller 20 can be one controller or a combination of interconnected controllers that are suitable for a steer by wire system of the type discussed herein. Many suitable controllers are available, as will be appreciated by those skilled in the art.

The vehicle operator steers the vehicle by a steering wheel 22. The steering wheel 22 is intended to represent any suitable steering wheel, steering mechanism, joy stick, etc. that can be employed in a steer by wire system. The vehicle operator rotates the steering wheel 22 to turn the wheels 12 and 14. When the steering wheel 22 is turned, a steering wheel shaft 24 is rotated. The shaft 24 is intended to represent any suitable structural device for a steer by wire system coupled to the steering wheel 22. The system 10 includes a position and torque sensor 26 that senses the rotation of the shaft 24. The sensor 26 can be any sensor suitable for a steer by wire control system of the type being discussed herein. The sensor 26 sends a signal to the controller 20 indicative of the rotational position of the steering wheel 22. Based on the position of the steering wheel 22, the controller 20 provides a motor drive signal to a steering motor 30 coupled to the axle 16. The steering motor 30 causes the vehicle wheels 12 and 14 to turn the appropriate amount to provide the steer by wire steering control.

The system 10 also includes a feedback motor 32 coupled to the shaft 24 that receives a feedback drive signal from the controller 20 in association with the motor drive signal applied to the motor 30. The feedback motor 32 applies a counter-torque to the shaft 24 in response to the vehicle operator turning the steering wheel 22 so that the vehicle operator feels a simulated effect of the wheels 12 and 14 turning on the roadway.

The steer by wire control system 10 also includes a mechanical back-up steering linkage 36 that mechanically couples the steering wheel 22 and the shaft 24 to the axle 16. The steering linkage 36 can be any mechanical linkage known in the art that is suitable for a steer by wire control system of the type discussed herein. The mechanical linkage 36 is a safety device that allows the vehicle operator to steer the vehicle in the event that the steer by wire system fails. In this regard, the steering linkage 36 could potentially be a less robust device than the steering linkages used in conventional vehicles because it would have limited use. In one embodiment, the linkage 36 can be a cable and could be coupled to the axle 16 by a rack and pinion gear system.

The linkage 36 includes a clutch 38 that allows the linkage 36 to be disengaged from the vehicle wheels 12 and 14 when the steer by wire system is operating properly. In this mode, the steering linkage 36 does not act to steer the vehicle. If a failure is detected by the controller 20, the controller 20 provides a clutch control signal to the clutch 38 to engage the clutch 38 to allow the steering linkage 36 to be used to steer the vehicle. The clutch 38 also provides a clutch position feedback signal to the controller 20 indicating whether it is engaged or disengaged.

According to the invention, the controller 20 also provides a torque assist signal to the feedback motor 32 to provide steering assist when the clutch 38 is engaged. In this mode, the motor 32 does not provide counter-torque to the shaft 24, but provides an assisting torque to the shaft 24 to help the operator turn the steering wheel 22 in the desired direction. Particularly, instead of providing a resistive torque to the steering wheel 22 during the steer by wire control, the motor 32 helps turn the steering wheel 22 in the direction that the vehicle operator is turning the steering wheel 22 so that the turning operation provided by the steering linkage 36 is not very difficult. The feedback motor 32 can be any motor suitable for the purposes described herein. Because the feedback motor 32 can be the same feedback motor used in the known steer by wire systems, there is no added cost or mass penalty provided by the present invention.

The controller 20 can control the feedback motor 32 in the assist mode so that the turning ratio provided by the motor 30 during the steer by wire mode and the turning ratio provided by the mechanical linkage 36 during the failure mode can be the same so that the transition from steer by wire to conventional steering is seamless. In the failure mode, the motor 32 operates as an electric power steering (EPS) system. In this embodiment, the EPS system is a column EPS because the motor 32 is provided in the steering column. In an alternate embodiment, the motor 32 can be provided in the rack and pinion gear system where the mechanical linkage 36 is coupled to the axle 16 to provide a rack EPS system.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A steer by wire control system for a vehicle, said vehicle including vehicle wheels, said system comprising:
a steering device for steering the vehicle wheels;
a mechanical steering linkage for mechanically coupling the steering device to the vehicle wheels, said mechanical steering linkage including a clutch for engaging and disengaging the steering linkage;
a position and torque sensor coupled to the steering device, said position and torque sensor generating a steering position signal indicative of the position of and torque applied to the steering device;
a steering motor coupled to the vehicle wheels for steering the vehicle wheels;
a feedback motor coupled to the steering device, said feedback motor providing torque to the steering device; and
a controller for controlling the control system, said controller receiving the steering device position signal from the position and torque sensor, said controller providing a motor drive signal to the steering motor for steering the vehicle wheels, a clutch control signal to the clutch for disengaging the clutch and a feedback signal to the feedback motor for providing a counter-torque to the steering device when the steer by wire control system is operating properly, said controller also providing a clutch signal to the clutch for disengaging the clutch and a steering assist torque signal to the feedback motor if the steer by wire system is not operating properly.

2. The system according to claim 1 wherein the steering device is a steering wheel.

3. The system according to claim 1 wherein the feedback motor operates as an electric power steering device if the steer by wire control system is not operating properly.

4. The system according to claim 3 wherein the feedback motor provides electric power steering selected from the group consisting of rack electric power steering and column electric power steering.

5. The system according to claim 1 wherein a steering ratio for the steer by wire and the mechanical linkage is about the same.

6. The system according to claim 1 wherein the vehicle wheels are front wheels.

7. A steer by wire control system for a vehicle, said vehicle including vehicle wheels, said system comprising:
a steering device for steering the vehicle wheels;
a mechanical steering linkage for mechanically coupling the steering device to the vehicle wheels, said steering linkage allowing the vehicle to be steered if the steer by wire control system is not operating properly;
a steering motor coupled to the vehicle wheels, said steering motor steering the vehicle wheels when the steer by wire control system is operating properly; and
a torque assist motor coupled to the steering device, said torque assist motor providing a torque assist for the steering device when the mechanical steering linkage is being used to steer the vehicle.

8. The system according to claim 7 wherein the torque assist motor operates as a feedback motor for providing a counter-torque to the steering device when the steering motor is being used to steer the vehicle wheels.

9. The system according to claim 8 further comprising a position and torque sensor coupled to the steering device, said position and torque sensor generating a steering position signal indicative of the position of the steering device to provide control of the steering motor and the assist motor.

10. The system according to claim 7 wherein the steering device is a steering wheel.

11. The system according to claim 7 wherein a steering ratio for the steering motor and the mechanical linkage is about the same.

12. The system according to claim 7 wherein the vehicle wheels are front wheels.

13. A method of steering a vehicle, said vehicle including vehicle wheels and a steering device for steering the vehicle wheels, said method comprising:
providing a mechanical steering linkage for mechanically coupling the steering device to the vehicle wheels;
sensing the position of the steering device;
electrically steering the vehicle wheels;
providing a counter-torque to the steering device in response to the electrical steering of the vehicle; and
providing a torque assist to the steering device if the steering linkage is steering the vehicle.

14. The method according to claim 13 wherein providing a counter-torque includes providing a feedback signal to a feedback motor coupled to the steering device.

15. The method according to claim 14 wherein providing a torque assist includes providing a signal to the feedback motor to provide the torque assist.

16. The method according to claim 13 further comprising providing a clutch coupled to the mechanical steering linkage, disengaging the clutch when the vehicle wheels are being electrically steered and engaging the clutch when the steering linkage is steering the vehicle wheels.

17. The method according to claim 13 wherein the steering device is a steering wheel.
